(19) United States
(12) Patent Application Publication
(10) Pub. No.: US 2014/0226362 A1
(43) Pub. Date: Aug. 14, 2014

(54) DECORATION ELEMENT AND ELECTRONIC DEVICE

(71) Applicant: Wistron Corporation, New Taipei City (TW)

(72) Inventors: Chien-An Chen, New Taipei City (TW); Chuan-Yi Liang, New Taipei City (TW); Yi-Jiun Lin, New Taipei City (TW); Jim-Da Lin, New Taipei City (TW)

(73) Assignee: Wistron Corporation, New Taipei City (TW)

(21) Appl. No.: 14/101,416

(22) Filed: Dec. 10, 2013

(30) Foreign Application Priority Data
Feb. 8, 2013 (TW) 102203091

(51) Int. Cl. F21V 8/00

(52) U.S. Cl. CPC G02B 6/0045
USPC 362/611

(57) ABSTRACT

A decoration element comprising a light guiding shell, a light guiding panel and a light source is provided. The light guiding shell has a light entrance, and comprises a first inclined plate, a second inclined plate, a first flat plate and a second flat plate. The first inclined plate is disposed on one side of the light entrance, while the second inclined plate is disposed on the other side of the light entrance. The first flat plate is connected to the first inclined plate, and the second flat plate is connected to the second inclined plate. The light guiding panel is disposed in the light guiding shell. The light source is disposed in the light entrance. The included angel between the first inclined plate and the second inclined plate ranges between 60 and 160 degrees.

This application claims the benefit of Taiwan application Serial No. 102203091, filed Feb. 8, 2013, the subject matter of which is incorporated herein by reference.

### BACKGROUND OF THE INVENTION

1. Field of the Invention

The invention relates in general to a decoration element, and more particularly to a decoration element used in an electronic device to make a light source brightest in the center and gradually dimmed towards the two sides.

2. Description of the Related Art

When using an electronic device, ordinary users wish that a decoration element of the electronic device can make a light source brightest in the center and gradually dimmed towards the two sides. According to the generally known technologies, at least three light sources (such as LED lamps) are respectively disposed in the center and two sides of the decoration element, and the luminance of the light sources in the two sides is adjusted to be lower than that of the e central light source so as to achieve the expected results.

However, using at least three light sources not only increases cost but also consumes more energy. Since the two sides of the decoration element of the electronic device are farther away from the light source, the light cannot be smoothly extended to the two sides when only one light source is used.

### SUMMARY OF THE INVENTION

The invention is directed to a decoration element which makes the illumination brightest in the center and gradually dimmed towards the two sides by using only one light source, not only saving cost and avoiding waste of energy, but also meeting the trend of lightweight and slimness in a limited space of the electronic device.

According to one embodiment of the present invention, a decoration element comprising a light guiding shell, a light guiding panel and a light source is provided. The light guiding shell has a light entrance, and comprises a first inclined plate, a second inclined plate, a first flat plate and a second flat plate. The first inclined plate is disposed on one side of the light entrance, while the second inclined plate is disposed on the other side of the light entrance. The first flat plate is connected to the first inclined plate, and the second flat plate is connected to the second inclined plate. The light guiding panel is disposed in the light guiding shell. The light source is disposed in the light entrance. The included angel between the first inclined plate and the second inclined plate ranges between 60 and 160 degrees.

According to another embodiment of the present invention, an electronic device comprising a housing and a decoration element is provided. The housing has an opening. The decoration element is disposed in the housing, and comprises a light guiding shell, a light guiding panel and a light source. The light guiding shell has a light entrance, and comprises a first inclined plate, a second inclined plate, a first flat plate and a second flat plate. The first inclined plate is disposed on one side of the light entrance, while the second inclined plate is disposed on the other side of the light entrance. The first flat plate is connected to the first inclined plate, and the second flat plate is connected to the second inclined plate. The light guiding panel is disposed in the light guiding shell, and has a light emitting surface. The opening of the housing exposes the light emitting surface. The light source is disposed in the light entrance. The included angle between the first inclined plate and the first flat plate and the included angle between the second inclined plate and the second flat plate both range between 120 and 175 degrees.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIGS. 1-9 are side cross-sectional views of a decoration element according to a first to a ninth embodiment of the present invention;

FIG. 10A is an illumination diagram of a decoration element according to the prior art; and

FIG. 10B is an illumination diagram of a decoration element according to the present invention,

### DETAILED DESCRIPTION OF THE INVENTION

The decoration element provided in an embodiment of the present invention comprises a light guiding shell, a light guiding panel and a light source. The light guiding shell has a light entrance, and comprises a first inclined plate, a second inclined plate, a first flat plate and a second flat plate. The first inclined plate is disposed on one side of the light entrance, while the second inclined plate is disposed on the other side of the light entrance. The first flat plate is connected to the first inclined plate, and the second flat plate is connected to the second inclined plate. The light guiding panel is disposed in the light guiding shell, The light source is disposed in the light entrance. The included angel between the first inclined plate and the second inclined plate ranges between 60 and 160 degrees.

In some embodiments, the included angle between the first inclined plate and the first flat plate and the included angle between the second inclined plate and the second flat plate may be set to be between 120 and 175 degrees.

Furthermore the decoration element of the present invention may be used in an ordinary electronic device, which comprises a housing and the decoration element of the present invention. The decoration element is disposed in the housing. The housing may have an opening which exposes a light emitting surface of the light guiding panel. Detailed descriptions of the present invention are disclosed in the first to the ninth embodiment below.

### First Embodiment

FIG. 1 is a side cross-sectional view of a decoration element 1 according to a first embodiment of the present invention. As indicated in FIG. 1, the decoration element 1 comprises a light guiding shell 10, a light guiding panel 20 and a light source 30. The light guiding shell 10 has a light entrance 100, and comprises a first inclined plate 101, a second inclined plate 102, a first flat plate 103 and a second flat plate 104. The first inclined plate 101 is disposed on one side of the light entrance 100, while the second inclined plate 102 is disposed on the other side of the light entrance 100. The first flat plate 103 is connected to the first inclined plate 101, and the second flat plate 104 is connected to the second inclined plate 102. The light guiding panel 20 is disposed in the light guiding shell 10. The light source 30 is disposed in the light entrance 100.

In the present embodiment, the light guiding panel 20 has a curved surface 200. a first inclined plane 201, a second inclined plane 202, a first plane 203 and a second plane 204. The curved surface 200 is disposed corresponding to the light entrance 100. The first inclined plane 201 is disposed on one side of the curved surface 200, while the second inclined plane 202 is disposed on the other side of the curved surface 200. The first plane 203 is connected to the first inclined plane 201 and the second plane 204 is connected to the second inclined plane 202.

As indicated in FIG. 1, the included angle between the first inclined plate 101 and the second inclined plate 102 is 120 degrees, and the included angle between the first inclined plane 201 and the second inclined plane 202 is also 120 degrees. That is, the included angle between the first inclined plane 201 and the second inclined plane 202 is equivalent to the included angle between the first inclined plate 101 and the second inclined plate 102.

In the present embodiment, the light guiding panel 20 has a light emitting surface 205, and both the included angle θ1 between the first flat plate 103 of the light guiding shell 10 and the light emitting surface 205, and the included angle θ1 between the second flat plate 104 of the light guiding shell 10 and the light emitting surface 205 are 3 degrees. However, the present invention is not limited thereto, and the included angle θ1 may range between 0 and 5 degrees.

It can be seen from FIG. 1 that both the included angle between the first plane 203 and the light emitting surface 205 of the light guiding panel 20 and the included angle between the second plane 204 and the light emitting surface 205 of the light guiding panel 20 are θ1, which may range between 0 and 5 degrees.

It can be known from the above disclosure that both the included angle θ2 between the first inclined plate 101 and the first flat plate 103 of the light guiding shell 10, and the included angle θ2 between the second inclined plate 102 and the second flat plate 104 may range between 150 and 155 degrees.

In addition, each of the joint between the first inclined plate 101 and the first flat plate 103 of the light guiding shell 10, the joint between the second inclined plate 102 and the second flat plate 104 of the light guiding shell 10, the joint between the first inclined plane 201 and the first plane 203 of the light guiding panel 20, and the joint between the second inclined plane 202 and the second plane 204 of the light guiding panel 20 has a radian. The joint regions A and A′ are circled with dotted lines. In the present embodiment, the curvature radius of the radian is 50 mm. However, the present invention is not limited thereto, and the curvature radius of the radian may range between 20 mm and 50 mm.

### Second Embodiment to Fifth Embodiment

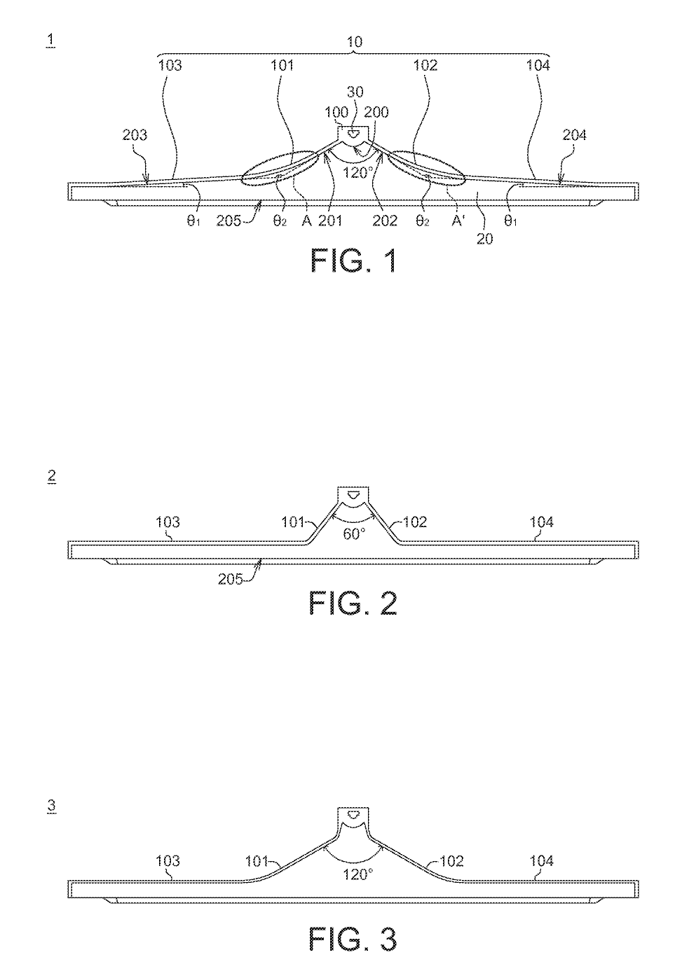

FIGS. 2-5 are side cross-sectional views of a decoration element according to a second to a fifth embodiment of the present invention. The second to the fifth embodiment are different from the first embodiment in the included angle between the first inclined plate and the second inclined plate of the light guiding shell, the included angle between the first flat plate and the light emitting surface, and the included angle between the second flat plate and the light emitting surface. Elements common to the first to the fifth embodiment retain the same numeric designations, and the similarities are not repeated.

In the decoration element 2 as illustrated in FIG. 2, the included angle between the first inclined plate 101 and the second inclined plate 102 of the light guiding shell is 60 degrees, and the first flat plate 103 and the second flat plate 104 of the light guiding shell are both parallel to the light emitting surface 205. That is, the included angle between the light emitting surface and the two flat plates 103, 104 is 0 degree. Similarly, the included angle between the first inclined plane and the second inclined plane of the light guiding panel is also 60 degrees. In other words, both the included angle between the first inclined plate 101 and the first flat plate 103 of the light guiding shell, and the included angle between the second inclined plate 102 and the second flat plate 104 of the light guiding shell are 120 degrees. However, the present invention is not limited thereto, The included angle between the first flat plate 103 and the light emitting surface 205, and the included angle between the second flat plate 104 and the light emitting surface also may range between 0 and 5 degrees, such that the included angle between the first inclined plate 101 and the first flat plate 103 of the light guiding shell, and the included angle between the second inclined plate 102 and the second flat plate 104 of the light guiding shell may range between 120 and 125 degrees.

In the decoration element 3 as illustrated in FIG. 3, the included angle between the first inclined plate 101 and the second inclined plate 102 of the light guiding shell is 120 degrees. Similar to the second embodiment, the included angle between the first inclined plate 101 and the first flat plate 103 of the light guiding shell, and the included angle between the second inclined plate 102 and the second flat plate 104 of the light guiding shell may range between 150 and 155 degrees.

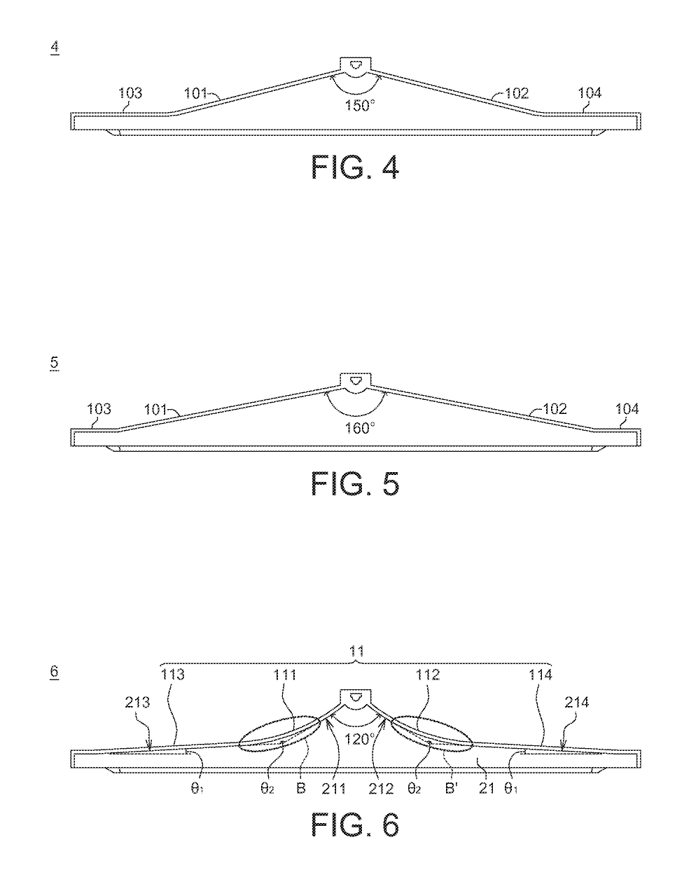

In the decoration element 4 as illustrated in FIG. 4, the included angle between the first inclined plate 101 and the second inclined plate 102 of the light guiding shell is 150 degrees. Similar to the second embodiment, both the included angle between the first inclined plate 101 and the first flat plate 103 of the light guiding shell, and the included angle between the second inclined plate 102 and the second flat plate 104 of the light guiding shell may range between 165 and 170 degrees.

In the decoration element 5 as illustrated in FIG. 5, the included angle between the first inclined plate 101 and the second inclined plate 102 of the light guiding shell is 160 degrees. Similar to the second embodiment, both the included angle between the first inclined plate 101 and the first flat plate 103 of the light guiding shell, and the included angle between the second inclined plate 102 and the second flat plate 104 of the light guiding shell may range between 170 and 175 degrees.

In the second to the fifth embodiment, the joint between the first inclined plate 101 and the first flat plate 103 of the light guiding shell, and the joint between the second inclined plate 102 and the second flat plate 104 of the light guiding shell do not necessarily have a radian as in the first embodiment.

### Sixth Embodiment

FIG. 6 is a side cross-sectional view of a decoration element 6 according to a sixth embodiment of the present invention. The present embodiment is different from the first embodiment in that each of the joint between the first inclined plate 111 and the first flat plate 113 of the light guiding shell 11, the joint between the second inclined plate 112 and the second flat plate 114 of the light guiding shell 11, the joint between the first inclined plane 211 and the first plane 213 of the light guiding panel 21, and the joint between the second inclined plane 212 and the second plane 214 of the light guiding panel 21 has a radian. The curvature radius of the radian is 20 mm. The joint regions B and B′ are circled with dotted lines. The similarities are not repeated here,

### Seventh Embodiment

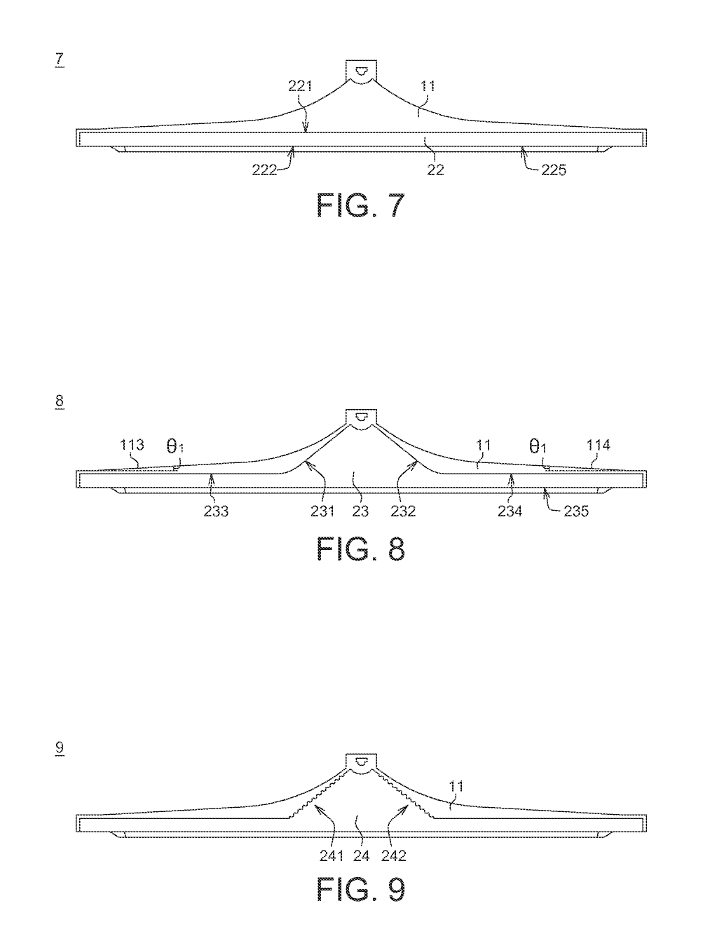

FIG. 7 is a side cross-sectional view of a decoration element 7 according to a seventh embodiment of the present invention. The decoration element 7 of the seventh embodiment and the decoration element 6 of the sixth embodiment have the same the light guiding shell 11, and the difference lies in that the light guiding panel 22 of the decoration element 7 is a flat plate whose upper surface 221 and lower surface 222 both are parallel to the light emitting surface 225.

### Eighth Embodiment

FIG. 8 is a side cross-sectional view of a decoration element 8 according to an eighth embodiment of the present invention. The decoration element 8 of the eighth embodiment and the decoration element 6 of the sixth embodiment have the same the light guiding shell 11, and the difference lies in that both the first plane 233 and the second plane 234 of the light guiding panel 23 of the decoration element 8 are parallel to the light emitting surface 235 and are connected to the first inclined plane 231 and the second inclined plane 232 respectively.

Since both the included angle between the first flat plate 113 of the light guiding shell 11 and the light emitting surface 235, and the included angle between the second flat plate 114 of the light guiding shell 11 and the light emitting surface 235 are 81, a larger gap is formed between the light guiding shell 11 and the light guiding panel 23. As a result, the light can be easily transmitted toward the two sides from the enter.

### Ninth Embodiment

FIG. 9 is a side cross-sectional view of a decoration element 9 according to a ninth embodiment of the present invention. The decoration element 9 of the ninth embodiment and the decoration element 8 of the eighth embodiment have the same light guiding she 11, and the difference lies in that the first inclined plane 241 and the second inclined plane 242 of the light guiding panel 24 of the decoration element 9 further form a stepped structure.

The stepped structure changes the refraction and reflection path of the light entering the light guiding shell 11, and helps the light to be transmitted to the two sides from the center.

The above embodiments are nine implementations of the present invention, but the present invention is not limited thereto. In comparison to the prior art, the decoration element of the present invention makes the illumination provided by a light source brightest in the center and gradually dimmed towards the two sides, not only saving cost and avoiding waste of energy, but also meeting the trend of lightweight and slimness in a limited space of the electronic device.

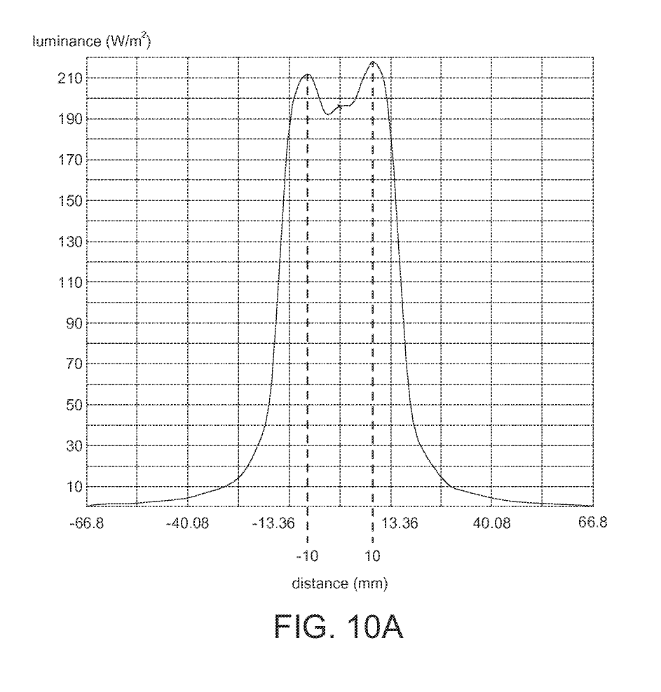

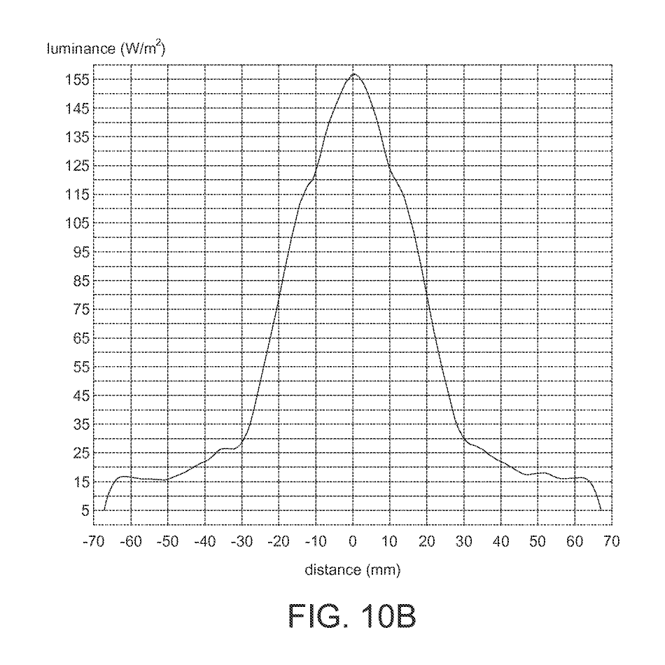

Besides, each light guiding panel disclosed in the above embodiments of the present invention has a curved surface (such as the curved surface 200 as illustrated in FIG. 1). The curved surface diffuses the light entering the light guiding panel, and helps the light to be scattered to the two sides of the decoration element. Moreover, each included angles in the light guiding shell and the light guiding panel disclosed in the embodiment of the present invention are significant and are elaborated with FIG. 10A and FIG. 10B below.

FIG. 10A is an illumination diagram of a decoration element according to the prior art. FIG. 10B is an illumination diagram of a decoration element according to the present invention. In the two diagrams, the x-axis denotes the distance between a particular position and the center of the decoration element; the y-axis denotes the luminance of the particular position. The center of the decoration element is the incident position of the light source and is defined as 0. The unit of distance is mm, and the unit of luminance is W/m². The measurement results of FIGS. 10 A and 10B are obtained by using one single light source.

In comparison to the luminance measured at a position 30 mm away from the center of the decoration element of the prior art is lower than 10 W/m² as indicated in FIG. 10A, the luminance measured at a position even more than 60 mm away from the center of the decoration element of the present invention is still larger than 15 W/m² as indicated in FIG. 10B.

As indicated in FIG. 10A, two extreme values of luminance are measured at positions about 10 mm away from the center of the decoration element of the prior art, and form a wave-pattern with ‘cat ears’. From the user's point of view, the two extreme values of luminance indicate two bright spots, and this is against the user's expectation of a decoration element making the light source brightest in the center and gradually dimmed towards the two sides. As indicated in FIG. 10B, the extremity of luminance occurs only at the center of the decoration element of the present invention, and the farther away from the center, the lower the luminance. This is user's desired decoration element making the light source brightest in the center and gradually dimmed towards the two sides.

The decoration element of the present invention can be used in an ordinary electronic device, which comprises a housing and the decoration element of the present invention. The decoration element is disposed in the housing. Through various implementations of the present invention in conjunction with other elements of the electronic device, a structure most suitable to the electronic device can be obtained so as to save the space.

The decoration element of the present invention makes the illumination provided by a light source brightest in the center and gradually dimmed towards the two sides, not only saving cost and avoiding waste of energy, but also avoiding the ‘cat ear’ illumination of the prior art using one single light source and meeting the trend of lightweight and slimness in a limited space of the electronic device.

While the invention has been described by way of example and in terms of the embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A decoration element comprising:
a light guiding she having a light entrance, comprising:
a first inclined plate disposed on one side of the light entrance;
a second inclined plate disposed on the other side of the light entrance;
a first flat plate connected to the first inclined plate; and
a second flat plate connected to the second inclined plate;
a light guiding panel disposed in the light guiding shell; and
a light source disposed in the light entrance;
wherein the included angel between the first inclined plate and the second inclined plate ranges between 60 and 160 degrees.

2. The decoration element according to claim 1, wherein the light guiding panel has a light emitting surface, and both the included angle between the first flat plate and the light emitting surface, and the included angle between the second flat plate and the light emitting surface range between 0 and 5 degrees.

3. The decoration element according to claim 1, wherein the light guiding panel has a curved surface, a first inclined plane, a second inclined plane, a first plane and a second plane, the curved surface is disposed corresponding to the light entrance, the first inclined plane is disposed on one side of the curved surface, the second inclined plane is disposed on the other side of the curved surface, the first plane is connected to the first inclined plane, the second plane is connected to the second inclined plane, and the included angle between the first inclined plane and the second inclined plane is equivalent to the included angle between the first inclined plate and the second inclined plate.

4. The decoration element according to claim 3, wherein both the included angle between the first plane and the light emitting surface, and the included angle between the second plane and the light emitting surface range between 0 and 5 degrees.

5. The decoration element according to claim , wherein the first inclined plane and the second inclined plane form a stepped structure.

6. The decoration element according to claim 3, wherein each of the joint between the first inclined plate and the first flat plate, the joint between the second inclined plate and the second flat plate, the joint between the first inclined plane and the first plane, and the joint between the second inclined plane and the second plane has a radian, and the curvature radius of the radian ranges between 20 mm and 50 mm.

7. An electronic device, comprising:
a housing having an opening; and
a decoration element disposed in the housing, wherein the decoration element comprises:
a light guiding shell having a light entrance, wherein the light guiding shell comprises:
a first inclined plate disposed on one side of the light entrance;
a second inclined plate disposed on the other side of the light entrance;
a first flat plate connected to the first inclined plate; and
a second flat plate connected to the second inclined plate;
a light guiding panel disposed in the light guiding shell, wherein the light guiding panel has a light emitting surface, and the opening exposes the light emitting surface; and
a light source disposed in the light entrance;
wherein both the included angle between the first inclined plate and the first flat plate, and the included angle between the second inclined plate and the second flat plate range between 120 and 175 degrees.

8. The electronic device according to claim 7, wherein both the included angle between the first flat plate and the light emitting surface, and the included angle between the second flat plate and the light emitting surface range between 0 and 5 degrees.

9. The electronic device according to claim 7, wherein the light guiding panel has a curved surface, a first inclined plane, a second inclined plane, a first plane and a second plane, the curved surface is disposed corresponding to the light entrance, the first inclined plane is disposed on one side of the curved surface, the second inclined plane is disposed on the other side of the curved surface, the first plane is connected to the first inclined plane, the second plane is connected to the second inclined plane, and both the included angle between the first inclined plane and the first plane, and the included angle between the second inclined plane and the second plane range between 120 and 175 degrees.

10. The electronic device according to claim 9, wherein both the included angle between the first plane and the light emitting surface, and the included angle between the second plane and the light emitting surface range between 0 and 5 degrees.

11. The electronic device according to claim 9, wherein the first inclined plane and the second inclined plane form a stepped structure.

12. The electronic device according to claim 9, wherein each of the joint between the first inclined plate and the first flat plate, the joint between the second inclined plate and the second flat plate, the joint between the first inclined plane and the first plane, and the joint between the second inclined plane and the second plane has a radian, and the curvature radius of the radian ranges between 20 mm and 50 mm
